(19) United States
(12) Patent Application Publication
(10) Pub. No.: US 2009/0017885 A1
(43) Pub. Date: Jan. 15, 2009

(54) CROP PROCESSING METHOD AND APPARATUS

(76) Inventor: Floyd W. HALLS, Edmonton (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 11/775,056

(22) Filed: Jul. 9, 2007

(51) Int. Cl. A01D 91/04; A01F 12/10; A01F 12/18

(52) U.S. Cl. 460/20; 460/59

(57) ABSTRACT

In a method for processing swathed crops, the entire cut crop is picked from the field and transported to a processing facility located away from the field. The processing facility has a threshing apparatus which separates grain from the cut crop, leaving a crop residue comprising plant stalks, chaff, and other constituents of the cut crop. The separated grain is conveyed from the threshing apparatus to a grain storage bin or directly to a transport truck for delivery to a grain terminal. The processing facility also includes crop residue handling means for conveying crop residue to a bulk storage pile, to a baling machine, or to some other selected location. The method makes field baling operations unnecessary, thus expediting the total removal of the crop from the field.

### FIELD OF THE INVENTION

The present invention relates in general to methods and apparatus for harvesting and processing crops, particularly crops used for animal feed.

### BACKGROUND OF THE INVENTION

Grain and hay crops of various kinds are commonly harvested using mobile combine harvesters (“combines”) after the crop has been swathed (i.e., cut and laid in windrows in the field). The combine picks up the swathed crop and threshes it to separate the grain kernels from the remainder of the crop (largely made up of plant stalks/straw, chaff, and weed seeds), which is then returned to the field. Threshed grain is stored in a grain hopper inside the combine, and the hopper is periodically emptied into grain trucks that transport the grain to storage bins.

It is commonly desirable to recover the plant stalks for uses including bedding for animals and as animal feed, either directly or as a constituent of a feed mix. This is typically accomplished by using a baler to gather the plant stalks from the field after combining operations are completed, and then forming the plant stalks into round or square bales. The bales are subsequently picked up and trucked to wherever they are needed.

The post-swathing aspects of the harvesting procedure described above require several pieces of equipment, including:
a mobile combine harvester (either self-propelled or pull-type);
grain trucks;
a baler; and
trucks for transporting bales from the field.

This procedure involves the following separate post-swathing field operations:
combining the swathed crop;
trucking grain from the combine to storage bins;
baling plant stalks deposited to the field by the combine; and
removing the bales from the field.

Optimal harvesting efficiency is always a function of weather conditions. Inclement conditions occurring after combining, such as rain or even snow, can delay the commencement of baling operations, and at the same time can cause deterioration in the quality and condition of the plant stalks in the field. Inclement conditions occurring after baling can delay the step of trucking the bales from the field.

Variations of the traditional combining methods can be found in the prior art. For example, U.S. Pat. No. 6,422,937 (McLeod) and U.S. Pat. No. 6,709,329 (McLeod et al.) disclose harvesting methods in accordance with which a harvested crop is cleaned at a site remote from the field, rather than by a combine in the field. In these methods, a field harvesting unit separates the plant stalks from the cut crop and returns the stalks to the field. The remainder of the cut crop, comprising grain, chaff, and weed seeds, is collected in the harvesting unit and subsequently transported to a cleaning plant which separates the grain, chaff, and weed seeds. In accordance with these harvesting methods, the chaff can be recovered for use in animal feeds, and the weed seed can be disposed of as desired (rather than being returned to the field, thus creating or adding to weed problems with next year's crop). In these methods, however, a separate field operation is still necessary in order to remove the plant stalks, by baling or otherwise.

A mixed farming operation may be understood as one in which the operator raises livestock in addition to growing crops. It is common in mixed farming operations to raise crops specifically for purposes of feeding the livestock. The present invention provides a method for processing swathed crops that is more efficient and requires less machinery than known traditional methods such as described above. The method of the invention is particularly beneficial when used in conjunction with mixed farming operations, but can also be beneficially adapted to other types of agricultural operations.

### BRIEF DESCRIPTION OF THE INVENTION

In general terms, the present invention encompasses methods and apparatus for processing crops whereby the removal of substantially all components of a cut crop from the field is expedited, and whereby the need for baling of straw or plant stalks in the field is eliminated. Instead of threshing or combining the cut crop in the field, and instead of leaving the plant stalks in the field, the entire cut crop, including plant stalks, is picked from the field and transported to a processing facility located some distance from the field. The processing facility has a threshing apparatus into which the cut crop is fed to separate the grain, leaving what for purposes of this patent specification may be referred to as a crop residue, comprising plant stalks, chaff, and other constituents of the cut crop that are remaining after the threshing process (possibly including some grain that did not get separated). The separated grain is conveyed from the threshing apparatus to a grain storage bin or directly to a transport truck for delivery to a grain terminal. The processing facility also includes crop residue handling means for conveying crop residue to a bulk storage pile, to a baling machine, or to some other selected location.

In a preferred embodiment of the method, the processing facility is sited close to a livestock feedlot associated with a mixed farming operation. Especially in a “balanced” mixed farming operation (i.e., one in which the size and type of crops are selected to match the feed requirements for the livestock aspect of the operation), the operator's machinery requirements can thus be greatly reduced. After being swathed, the crop is transported to the threshing apparatus of the processing facility. The grain is separated from the cut crop, and the crop residue is conveyed from the threshing apparatus by crop residue handling means, which deposits the residue in a stack or pile for use as feed. The feed stacks can be positioned very close to livestock feeding areas, thus minimizing the need for further manual or mechanized handling of the feed material to get it to the livestock. Preferably, the crop residue handling means incorporates a feed blower with a telescoping vertical section and a swivelling lateral discharge arm, to facilitate building feed stacks in different locations and to different heights. Storage of feed in stacks is preferable to bale storage in many applications. Because the ratio of exposed surface area to total volume is significantly greater for a typical haystack than for even a large hay bale, hay generally stays in better condition in a haystack than in a bale, because a higher proportion of the total hay volume is protected from weather and other factors that could cause deterioration.

For a balanced mixed farming operation as described above, all the operator needs in the way of field equipment after the crop has been swathed is a truck and a suitable implement for loading the swathed crop into the truck for transport to the processing facility at the feedlot. The threshing apparatus and crop residue handling means at the processing facility can have a self-contained drive mechanism, complete with a gas or diesel engine or even an electric drive mechanism. However, particular economies can be achieved by adapting all the apparatus at the processing facility to be operable by connection to the power take-off of a typical farm tractor. This will reduce the cost of the machinery at the processing facility, and will promote optimal and efficient use of the tractor that the farm operator would almost certainly have in any case.

In accordance with this method, the entire cut crop is loaded and transported out of the field, without any processing being carried out in the field. All that needs to be done in the field is to pick up the crop, and this step will take less time, labor, and energy cost than traditional combining, since the combine harvester must not only pick up the cut crop but also thresh the crop to separate the grain. Therefore, using the method of the present invention, all components of the cut crop can be removed from the field sooner than would be possible using traditional harvesting methods—much sooner, in fact, considering that traditional harvesting methods require additional field operations for baling and removal of bales. The present method thus minimizes the required extent and duration of field operations, thus minimizing the risk of delay or crop damage or loss due to factors such as weather, birds, and wildlife. At the same time, the method minimizes the equipment and labor needed to remove the crop from the field.

Accordingly, in one aspect the present invention is a method for processing a cut grain crop, comprising the steps of:
(a) loading at least a portion of the cut grain crop from the field into one or more transport vehicles;
(b) transporting the cut grain crop to a processing facility having:
   b.1 threshing means, for separating grain from the cut crop; and
   b.2 crop residue handling means, for conveying crop residue away from the threshing means;
(c) feeding the cut grain crop into the threshing means, thus separating grain from the cut crop and leaving a crop residue; and
(d) using the crop residue handling means to convey the crop residue to a crop residue discharge site.

The threshing means may be a stationary threshing machine, but in alternative embodiments it could be a mobile threshing machine that can be moved to a storage location when it is not needed for processing crops. The threshing means will include accessory equipment such as a thresher table for receiving the cut crop either directly from field trucks or from a conveyor onto which the cut crop has been unloaded from the field trucks.

In preferred embodiments, the crop residue handling means includes a blower operably connected to a discharge chute. The discharge chute preferably can be swiveled about a vertical axis, and even more preferably has a telescoping vertical section, thus increasing the operator's options as to the location of the crop residue discharge site and the height to which crop residue can be piled. The nature of the crop residue discharge site can vary without departing from the principles and concepts of the invention. In common applications, it will be a simple stack formed on the ground in the vicinity of the processing facility. Alternatively, it could be a baling apparatus, or even a truck for conveying crop residue to a disposal site or secondary processing facility.

In another embodiment, the processing facility is transportable, and for this purpose may be a trailer-mounted crop-processing module or, more preferably, a modular processing facility comprising individual wheel-mounted modules which may be connected or positioned for cooperative use. This embodiment provides the operator with additional options and flexibility with respect to where the cut crop is processed, while retaining practical and economic benefits as previously described. It is common for livestock to be moved periodically rather than being kept at a single location (such as a feedlot). Therefore, it may be desirable to store quantities of feed in a number of locations, and this can be conveniently accomplished using the method of the present invention in conjunction with a trailer-mounted or modular crop-processing facility. The modular variant also provides flexibility with respect to the specific equipment needed for handling different types of crops (e.g., grain crops as opposed to non-grain hay crops), as will be explained.

Accordingly, in a second aspect the present invention is a trailer-mounted or wheeled, modular crop-processing apparatus incorporating a threshing machine (with accessories and appurtenances for loading cut crops into the threshing machine) and crop residue handling means. In the preferred embodiment of the crop-processing module, the crop residue handling means incorporates a feed blower with a telescoping vertical section and a swivelling lateral discharge arm.

### BRIEF DESCRIPTION OF THE DRAWINGS

Embodiments of the invention will now be described with reference to the accompanying figures, in which numerical references denote like parts, and in which:

FIG. 1 is a plan view of an agricultural field, schematically depicting windrowed cut crops being removed from the field in accordance with one embodiment of the method of the present invention.

FIG. 2 is an elevation of a crop-processing apparatus in accordance with one embodiment of the invention.

FIG. 3 is a plan view of a processing facility as in FIG. 2.

### DETAILED DESCRIPTION OF THE PREFERRED EMBODIMENT

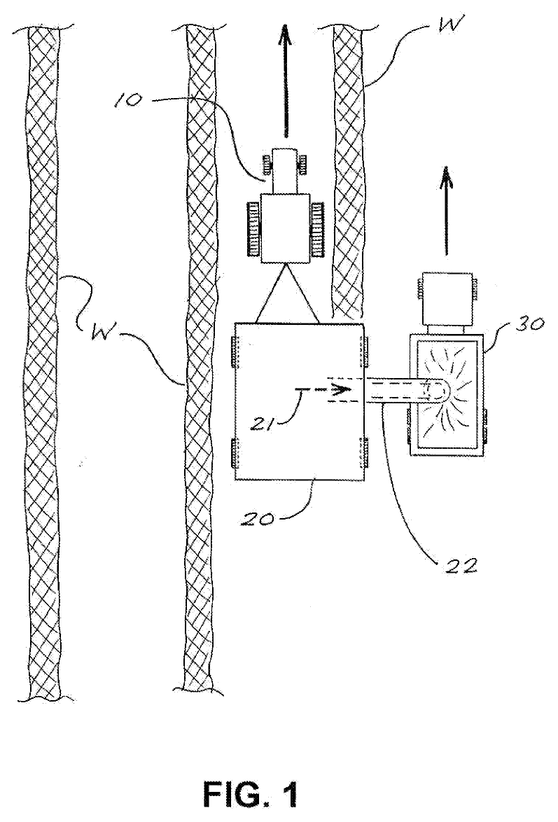

FIG. 1 schematically illustrates, in plan view, a farm field with a swathed crop in windrows W, are being collected in accordance with an initial step of one embodiment of the method of the invention. A tractor 10 pulls a pull-type harvester 20 which picks up the swathed crop and discharges it (as conceptually indicated by flow arrow 21 and discharge chute 22) into a field truck 30, which will in turn transport the crop to a processing facility in accordance with the invention. Numerous readily-available implements could be used as harvester 20; one example would be a pull-type forage harvester or pickup head as manufactured by the John Deere® company. In alternative embodiments, a self-propelled harvester could be used instead of a tractor/pull-type harvester combination.

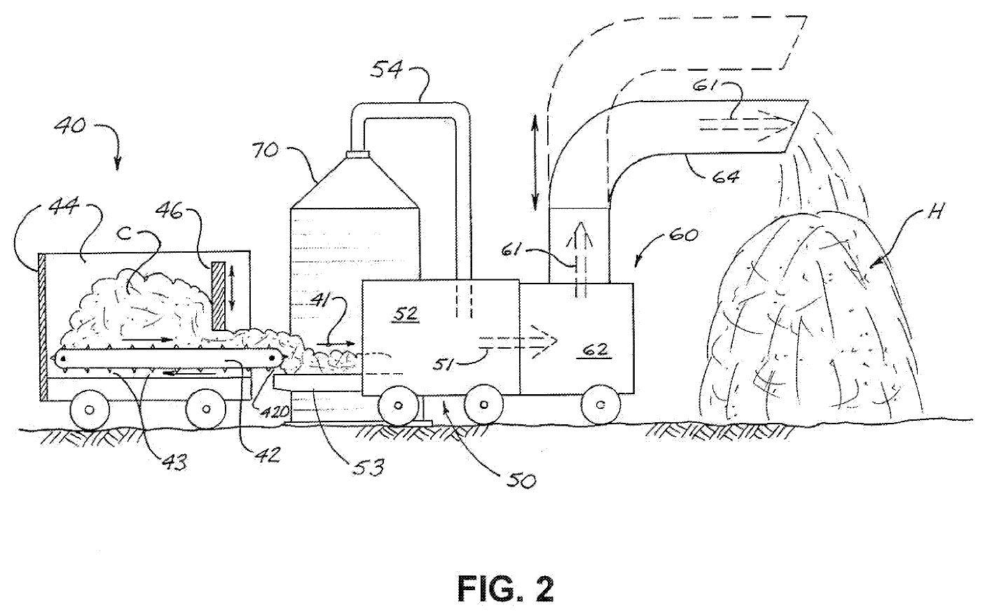

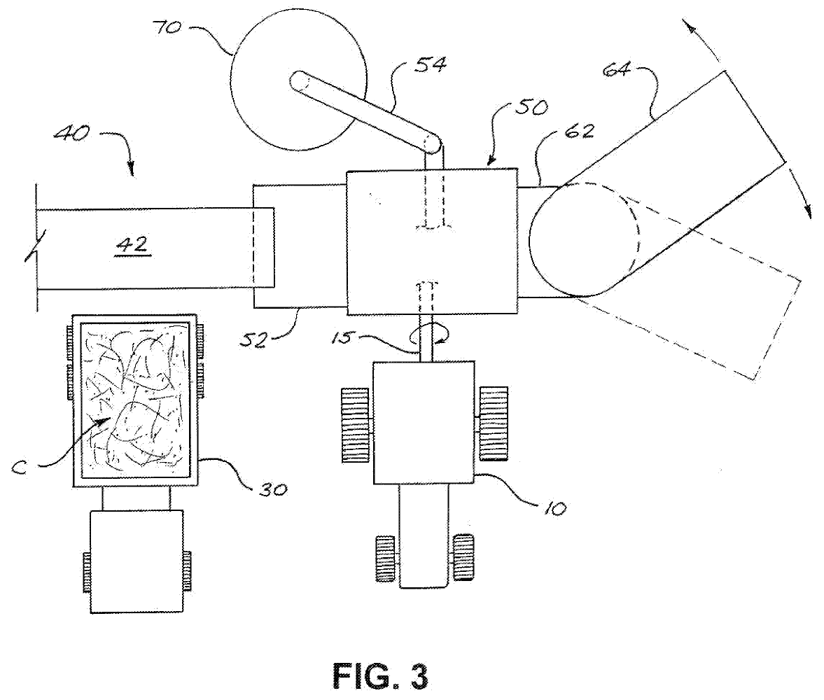

FIGS. 2 and 3 illustrate a crop-processing facility in accordance with a preferred embodiment of the apparatus of the invention. In this embodiment, the facility includes a wheel-mounted crop unloading module 40 having a conveyor 42 onto which field trucks 30 can unload a swathed-crop C. Conveyor 42 has a discharge end 42D, and may be of any known type suitable for handling crops; for example, it could comprise a conveyor belt (with or without transverse ribs 43), or it could comprise an auger-type conveyor or a drag conveyor. Although illustrated as a comparatively compact unit, unloading module 40 may be scaled up as desired or appropriate to suit the processing capacity of the facility, and the type and number of field trucks 30 to be used in a given application.

Unloading module 40 may have walls 44 to facilitate retention of swathed crop C upon conveyor 42. Unloading module 40 preferably incorporates regulator means 46 for regulating the rate (on either a weight or bulk volumetric basis) at which crop C is discharged at discharge end 42D of conveyor 42. In FIG. 2, regulator means 46 is conceptually illustrated as a vertically-adjustable screed or gate that regulates the crop discharge rate by controlling the bulk depth of crop C as it approaches discharge end 42D of conveyor 42. However, persons skilled in the field of the invention will appreciate that regulator means 46 could take alternative forms or could achieve its function in other ways (including by regulation of conveyor speed).

The apparatus also incorporates threshing means, which in the illustrated preferred embodiment is in the form of a wheeled thresher module 50 having a threshing unit 52 and thresher table 53 for receiving crop C off discharge end 42D of conveyor 42 and transferring crop C into threshing unit 52 (as schematically indicated by flow arrow 41). Threshing unit 52 separates grain from crop C and discharges it to a storage bin 70 (or, alternatively, to a grain transport truck) through grain conduit 54. Although illustrated as a pipe or chute, grain conduit 54 could alternatively be provided in the form of a bucket elevator, grain auger, or other device suitable for the purpose.

As schematically indicated by flow arrow 51, crop residue remaining after grain has been separated from crop C is transferred to a crop residue handling unit, which in the illustrated embodiment is a wheeled crop residue handling module 60 comprising a feed blower 62 with a discharge chute 64. As schematically indicated by dashed outlines in FIGS. 2 and 3, discharge chute 64 is preferably adjustable in height and also horizontally swivellable (as schematically indicated in FIG. 3) As schematically indicated by flow arrows 61 in FIG. 2, feed blower 62 discharges crop residue from threshing unit 52 through discharge chute 64 onto a haystack H, the location and height of which can be varied by adjusting the height and angular orientation of discharge chute 64. In alternative embodiments, crop residue handling module 60 could be adapted to discharge crop residue to a baling machine or into transport trucks.

Providing the crop-processing apparatus of the invention in modular form, as described above, facilitates efficient use of equipment to suit different types of crops. As described and illustrated, the modular apparatus is configured to handle grain crops (e.g., barley). However, with non-grain hay crops (e.g., alfalfa), thresher module 50 is not needed, so such crops could be processed with a modified apparatus assembled by coupling unloading module 40 with crop residue handling module 60. This will be particularly advantageous where it is desired to provide feed stacks in a number of different locations (e.g., close to livestock feeding areas in the field), and where it is desirable to vary the feed stack locations from time to time. In other applications, such as where a mixed farm operator has a fixed-location feed lot, there may be no need for the crop-processing apparatus to be readily transportable, in which ease it can be made up of stationary rather than modular units.

Thresher module 50 may incorporate its own power system. As schematically indicated in FIG. 3, however, thresher module 50 could also be adapted for operative coupling to the power take-off 15 of a farm tractor 10, thus reducing the cost of thresher module 50, and promoting more efficient use of tractor 10.

It will be readily appreciated by those skilled in the art that various modifications of the present invention may be devised without departing from the essential concept of the invention, and all such modifications are intended to come within the scope of the present invention and the claims appended hereto. It is to be especially understood that the invention is not intended to be limited to illustrated embodiments, and that the substitution of a variant of a claimed element or feature, without any substantial resultant change in the working of the invention, will not constitute a departure from the scope of the invention.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

What is claimed is:

1. A method for processing a cut grain crop, comprising the steps of:
(a) loading at least a portion of the cut grain crop from the field into one or more transport vehicles;
(b) transporting the cut grain crop to a processing facility having:
b.1 threshing means, for separating grain from the cut crop; and
b.2 crop residue handling means, for conveying crop residue away from the threshing means;
(c) feeding the cut grain crop into the threshing means, thus separating grain from the cut crop and leaving a crop residue; and
(d) using the crop residue handling means to convey the crop residue to a crop residue discharge site.

2. The method of claim 1 wherein the threshing means is stationary.

3. The method of claim 1 wherein the threshing means has a self-contained drive mechanism.

4. The method of claim 1 wherein the threshing means is adapted for operable connection to a power take-off associated with a mobile power unit.

5. The method of claim 1 wherein the crop residue handling means comprises a feed blower, and comprising the additional step of using the feed blower to stack crop residue.

6. The method of claim 5 wherein the feed blower incorporates a telescoping vertical section and a swivelling lateral discharge arm

7. The method of claim 1 wherein the processing facility further comprises baling means, and comprising the additional step of using the baling means to bale crop residue conveyed to the baling means using the crop residue handling means.

8. The method of claim 1 wherein the processing facility is stationary.

9. The method of claim 1 wherein the processing facility is transportable.

10. The method of claim 9 wherein the processing facility is a modular apparatus, with the threshing means comprising a wheeled threshing module, and with the crop residue handling means comprising a wheeled crop residue handling module.

11. The method of claim 1 wherein the processing facility is sited in association with a livestock feed operation.

12. A mobile crop-processing apparatus comprising:
(a) a wheeled threshing module, for separating grain front a cut crop; and
(b) a wheeled crop residue handling module, for conveying crop residue away from the threshing means.

13. The mobile crop-processing apparatus of claim 12, further comprising a wheeled crop-unloading module having conveyor means for receiving a cut crop and for feeding same into the threshing module.

14. The mobile crop-processing apparatus of claim 13, further comprising regulator means for regulating the crop feed rate crop into the threshing module.

15. The mobile crop-processing apparatus of claim 13 wherein the threshing module can be uncoupled from the apparatus and the crop-unloading module can be operatively coupled to the crop residue handling module so as to load a cut crop directly into the crop residue handling module.

16. The mobile crop-processing apparatus of claim 12 wherein the crop residue handling module comprises a feed blower.

17. The mobile crop-processing apparatus of claim 16 wherein the feed blower incorporates a telescoping vertical section and a swivelling lateral discharge arm.

18. The mobile crop-processing apparatus of claim 15 wherein the crop residue handling module comprises a feed blower.

19. The mobile crop-processing apparatus of claim 18 wherein the feed blower incorporates a telescoping vertical section and a swivelling lateral discharge arm.
